(19) United States
(12) Patent Application Publication
(10) Pub. No.: US 2010/0294143 A1
(43) Pub. Date: Nov. 25, 2010

(54) Classification of Impinging Bodies

(76) Inventors: Peter Schmitt, Erlangen (DE); Oliver Scholz, Moehrendorf (DE); Guenther Kostka, Erlangen (DE)

Correspondence Address: GLENN PATENT GROUP, 3475 EDISON WAY, SUITE L, MENLO PARK, CA, 94025, US

(21) Appl. No.: 12/377,968

(22) PCT Filed: Jul. 5, 2007
(86) PCT No.: PCT/EP2007/005978

§ 371 Date: Aug. 9, 2010

(30) Foreign Application Priority Data
Aug. 22, 2006 (DE) 10 2006 039 390.2

(51) Int. Cl. B07C 5/34; A23N 4/02

(52) U.S. Cl. 99/547; 209/600

(57) ABSTRACT

Objects impinging on an impingement body may be classified, with regard to their properties, in an efficient and highly reliable manner when the chronological acceleration profile caused by the object impinging on the impingement body is evaluated so as to classify the object.

### CROSS-REFERENCE TO RELATED APPLICATIONS

This application is a national phase entry of PCT Patent Application Serial No. PCT/EP2007/005978, filed 5 Jul. 2007, which claims priority to German Patent Application No. 102006039390.2-23, filed 22 Aug. 2006.

### BACKGROUND OF THE INVENTION

The present invention relates to the classification of impinging bodies, and in particular to how a body impinging on an impingement body may be classified, for example, with regard to its material properties or material type.

A form of applying such classification of impinging bodies which is of particular industrial interest is the recognition of stones which have been removed from pieces of stone fruit and impinge on the impingement body.

Reliable stoning of stone fruit such as cherries or plums on an industrial scale is important, since with a stone not fully removed, a consumer may suffer injuries to their teeth when eating stone fruit.

In the stoning processes which are customary on an industrial scale, the stones are mechanically removed from stone fruit, wherein a ram is pushed through the fruit to be stoned, and the stone is removed from the fruit in the process, as is customary with home cherry stoners. On an industrial level, several pieces of stone fruit are initially sorted into a holding device in discrete portions of variable sizes. The holding device, which has the shape of a roller, for example, is made such that it receives the fruit in defined, discrete positions. In the actual stoning process, a ram, which is driven pneumatically, for example, is mechanically pushed through the fruit, the stone of the fruit being removed from the fruit on that side which is opposite the entry point of the ram.

Problems arise when the stone is not centrally hit by the ram, for in this case it may happen that the stone is either not removed from the fruit or is split in two by the decentral impact of the ram, and that only parts of the stone are removed from the fruit. For the above reasons, it is indispensable to check whether the stone has been completely removed from the fruit.

Use is made, inter alia, of inspection methods which include checking whether parts of the stone still remain within the fruit after the stoning process, it being possible to divide the methods up in non-destructive methods and methods wherein the fruit is mechanically modified. One example of the latter tactile methods is described in DE4306515A1. According to said document, mechanical verification of the success of the stoning process is performed in that test needles are driven into the fruit, the penetration depth of the needles being used as a criterion for the presence of a stone, exploiting the fact that the needles cannot penetrate a hard stone.

Since with the tactile methods, the fruits are mechanically modified or even partially destroyed, non-destructive testing methods are sometimes advantageous, as are proposed in DE2538799A1, for example. According to said document, the fruit is X-rayed after the stoning process so as to detect any stone which may have remained inside the pulp. The non-destructive testing by means of X-radiation, wherein the fruit is X-rayed to see whether the stone is still inside the fruit, has the disadvantage that, as a rule, reliable detection of any stones remaining inside the fruit is not possible within a product stream. Namely, inside the fruit, the stone is entirely surrounded by pulp, which fact is accompanied by the X-ray photographs depicting only a small contrast difference due to the high water content of the pulp, and as a result, a stone inside the fruit is hard to identify. Therefore, it is only with freeze-dried and, consequently, dehydrated fruit that the stones remaining inside the stone fruits may be reliably detected. This is possible, for example, with freeze-dried cherries.

The German patent 10 2005 018 639 describes a method aimed at observing the stoning process using X-ray technology, and therefore confirming reliable stoning. If no stone can be observed within a predefined time window, it will be assumed that the stone has remained within the stone fruit, and a corresponding error message is output. Utilization of X-ray technology causes considerable cost in terms of, inter alia, the X-ray source, the high-voltage generator and radiation protection.

Methods which, like the above-described X-ray method, aim at identifying the stone of, e.g., cherries or plums which has been removed from the fruit circumvent most of the above-described problems.

With such methods, the problem is generally to be able to distinguish the stone from any pulp which has alternatively or additionally been removed from the fruit body, so as to confirm successful stoning of a piece of stone fruit. To this end, it is essential to classify the body to be examined, and/or to identify physical parameters of the body in a suitable manner.

Of course, the task to be achieved is not limited to the stoning of stone fruit. Rather, a number of technical applications have been known wherein an object must may be reliably classified. Mention shall be made in this context, by way of example, of sorting soy beans, which involves having to sort the beans into “good” and “bad” beans.

According to an embodiment, an apparatus for classifying an object impinging along an object path may have: an impingement body arranged within the object path; an acceleration sensor for sensing a chronological acceleration profile of the impingement body upon impingement of an object; and a classifier for classifying the object on the basis of the chronological acceleration profile.

According to another embodiment, a method of classifying an object impinging along an object path may have the steps of: sensing, by means of an acceleration sensor, a chronological acceleration profile of an impingement body, which is arranged within the object path, during deflection of the impingement body from a resting position upon impingement of the object; and classifying the object on the basis of the chronological acceleration profile.

According to another embodiment, a stoning apparatus for stone fruit may have: a stoner for removing tissue along an object path from the stone fruit; an impingement body arranged within the object path; an acceleration sensor for sensing a chronological acceleration profile of the impingement body upon impingement of the tissue; and a classifier for recognizing a stone within the tissue on the basis of the chronological acceleration profile.

The core idea of the present invention is that any objects impinging on an impingement body may be classified, with regard to their properties, more efficiently and with a higher level of reliability when the chronological acceleration profile caused by the object impinging on the impingement body is evaluated in order to classify the object.

In an embodiment of the present invention, an impingement body is arranged within an object path, along which an object to be classified is moving. The impingement body further comprises a means for sensing a chronological acceleration profile of the impingement body, said means measuring the acceleration profile at the impingement body upon impingement of the object.

Measuring the acceleration results in the major advantage, in particular, that the impulse transfer to, or the impact of force on, the impingement body which is caused by the object may be determined with the highest time resolution possible.

As compared to methods which, for example, determine the speed or the deflection of a body hit by an object, the above method has the great advantage that maximum information may be obtained, since speed and positional information are already integral quantities which may be concluded, for example, by integrating the acceleration profile. If, according to the invention, the acceleration can be determined directly in a time-resolved manner, it will be possible to closely observe impingement of the object, or the force transferred to the impingement body by the impinging object, during impingement itself (in a time-resolved manner).

Therefore, the inventive method is particularly suited for reliably separating resilient from non-resilient objects, which may even have identical masses. This is particularly relevant if reliable stoning of stone fruit is to be confirmed, where a distinction is to be made between an impinging stone and pulp impinged upon, the stone constituting a hard, non-resilient material, and the pulp constituting a soft, extremely resilient material.

Since the inventive concept of classifying an impinging object may be presented in a particularly graphic manner by using the example of checking the stoning process of stone fruit, the following description will illustrate, without limiting the generality, the inventive concept in terms of stoning pieces of stone fruit.

In a specific embodiment of the present invention, it is therefore ensured by suitable measures such as a suitable mechanical arrangement that the fruit components removed from the fruit, such as the stone or juice, can only come out along a predetermined object path.

Thus, if the stone or pulp comes out of a fruit, the stone or the pulp will impinge on the impingement body located in the object path, the acceleration profile determined at the deflected impingement body being used to clearly differentiate between the stone and the pulp.

Thus, it may be ensured that the fruit stone is indeed removed from the fruit during stoning if impingement of the stone on the sensor is detected. Otherwise, an error message will occur, so that non-stoned pieces of fruit may be removed from the product stream.

Identifying the stone even after the stoning process by means of the force transferred to an impingement body or by means of the acceleration of the impingement body which may be determined therefrom results in the great advantage over conventional approaches that the proportion of non-stoned fruit may be reduced considerably.

In a further embodiment of the present invention, the impingement body is implemented as a spring-steel lamella fixed on one side, so that an impinging stone or an impinging object transmits a force to the spring-steel lamella, which is deflected and/or accelerated. After each deflection, an acceleration sensor, or an apparatus for measuring the acceleration, may be returned to a resting position, which in the case of the spring-steel lamella occurs automatically because of the material properties of the spring steel.

In a further embodiment of the present invention, the impingement body is spring-mounted on at least three sides, so that acceleration information may be determined not only in one dimension, since, if the object impinges in a non-central manner, the impingement body may also be tilted, so that when using a three-dimensional acceleration sensor, the direction of the acceleration, i.e. direction of impingement of the stone or pulp, may also be reconstructed. This may be useful particularly when, e.g., a cherry stone was not centrally hit by a ram, so that it will not centrally hit the impingement body. If the cherry stone is non-centrally hit by the ram, there is a danger of splitting the cherry stone in two, so that a fragment of the cherry stone will remain inside the cherry. By utilizing the impingement body, which is positioned in accordance with the invention, additional information may thus be obtained on whether or not there is a risk that the stone has not been completely removed.

In a further embodiment of the present invention, the acceleration information is utilized by a classification means in order to distinguish stones from pulp. The profile of the acceleration is characteristic, among other things, of the hardness, but also of the energy inherent in the impinging body. A hard impinging object, such as a fruit stone, for example, is not deformed upon impact and will release its energy directly to the target area (the impingement body) and to any return spring that may be associated therewith. A soft impinging object, such as the pulp, for example, is deformed upon impact, which means that the energy is only partly transmitted to the target area. The integral over the acceleration profile provides insight into the energy transmitted to the target area in total, and it may therefore be used as an additional classification criterion. From this, e.g. the mass of an impinging object may be determined if its speed is known. In the case of stoning, for example, said speed is identical with the (known) speed of a ram used for stoning.

However, what is crucial is direct evaluation of the chronological acceleration profile, since the entire additional information may be obtained by temporally integrating the acceleration. By observing the characteristic of the acceleration profile, the presence of any hard body becomes immediately apparent, since the acceleration reaches its maximum as early as at the start of the curve, in contrast with the soft body, where a continuous acceleration profile results.

### BRIEF DESCRIPTION OF THE DRAWINGS

Embodiments of the present invention will be detailed subsequently referring to the appended drawings, in which:

FIG. 1 shows a schematical representation of an apparatus for checking the success of a process of stoning stone fruit, and its integration into the production process;

FIG. 2 shows an example of an inventive apparatus for classifying an object;

FIG. 3 shows a further example of an inventive apparatus for classifying an object;

FIG. 4 shows an example of an inventive impingement body; and

FIG. 5 shows a further example of an inventive impingement body.

### DETAILED DESCRIPTION OF THE INVENTION

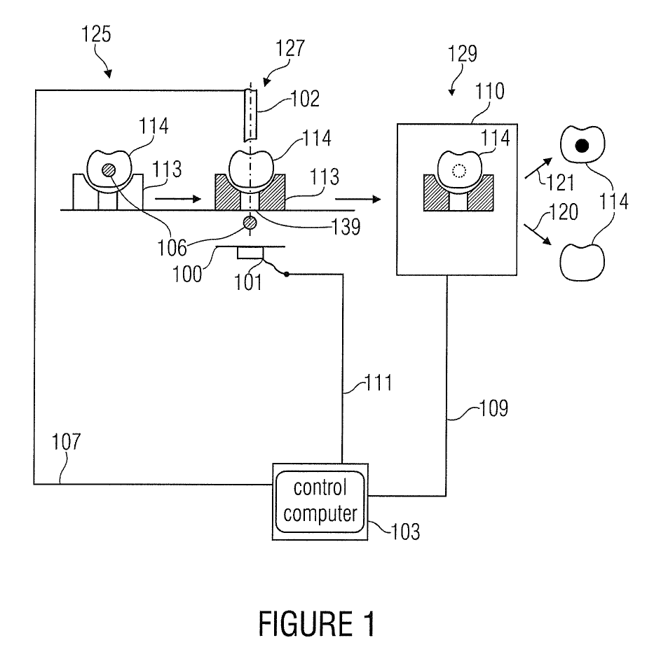

FIG. 1 shows an apparatus for checking the success of the process of stoning a piece of stone fruit in accordance with an embodiment of the present invention. A cherry shall serve as an example of a piece of stone fruit, it being possible, however, to use the present invention for any other type of stone fruit.

The apparatus for checking the success of the stoning process includes an impingement body 100, a means for sensing a chronological acceleration profile 101, a ram 102, and a control computer, or classification means, 103. The control computer 103 is connected to a means for actuating a ram 102 via a signal line 107, and to a sorting system 110 via a further signal line 109. The means for sensing a chronological acceleration 101 is connected to the control computer 103 via a signal line 111.

In addition, a holding means 113 is provided which has a cherry 114 located therein during the process of stoning by the ram 102, and from which said cherry is removed and output, after the stoning process, by the sorting system 110 along a first path 120 or a second path 121. Selection of the path 120 or 121 is conducted as a function of whether the stoning process was indicated as being successful or unsuccessful by the control computer 103. In this context, FIG. 1 shows, in section 125, the time instant prior to the stoning process, in section 127, the time instant during the stoning process, and in 129, the time instant after the stoning process.

During operation, the cherry 114 is guided by the holding means 113 in a defined position. In the actual stoning process 127, the ram 102 is pushed through the cherry 114 in a central manner, so that, ideally, the stone 106 of the cherry is completely removed from the cherry by the ram 102. The geometry of the equipment is designed such that, by said geometry, an object path is specified, along which the stone 106 or the tissue which alternatively or additionally has been released from the fruit must may move. To achieve this, the cherry 114 is located within a trough of the holding means 113, a bore 139 being located within the holding means 113 below the cherry, the diameter of said bore 139 being sufficiently small as to prevent the cherry 114 from falling through the bore 139. On the other hand, the diameter of the bore 139 may be slightly larger than the diameter of the cylindrical ram 102, so that the latter may enter into the bore 139 from the holding means 113. In the stoning process, the ram 102 completely penetrates the cherry 114, for example, and also passes through the bore 139, so that the tissue removed from the cherry will inevitably be pushed out of the bore 139 below the holding means 113. The tissue removed will fall downward under the influence of gravity.

To be able to temporally synchronize the measuring result of the means for sensing a chronological acceleration profile 102 with a stoning process, the control computer 103 is coupled to the ram 102, which performs the stoning, via the signal line 107, the control computer either being able to actively control the start of the stoning process or obtaining from the ram 102 a signal as a notification as to when the stoning process to be monitored takes place.

Depending on the success or failure of the stoning process, the control means 103 may control, via the signal line 109, the sorting system 110 such that any pieces of stone fruit which are completely stoned are separated from incompletely stoned pieces of stone fruit in that the completely stoned pieces of fruit take the first path 120, whereas any incompletely stoned pieces of fruit, i.e. also those which still contain fragments of a stone, follow the second path 121.

As may be seen from FIG. 1, the impingement body 100 is geometrically arranged, with the means for sensing a chronological acceleration profile 101, such that it is located within an object path along which the exiting cherry stone or the exiting pulp is moving. Additionally, provision may be made in this context for the object path to be geometrically restricted by further structural measures. These may include, for example, baffle walls, or a cylindrical enclosure of the impingement body, which is flush with the underside of the holding means 113, so that the bore 139 is located within the cylindrical border.

To differentiate a stone from pulp, a time resolution of the measured acceleration profile is sufficient in this context, for example.

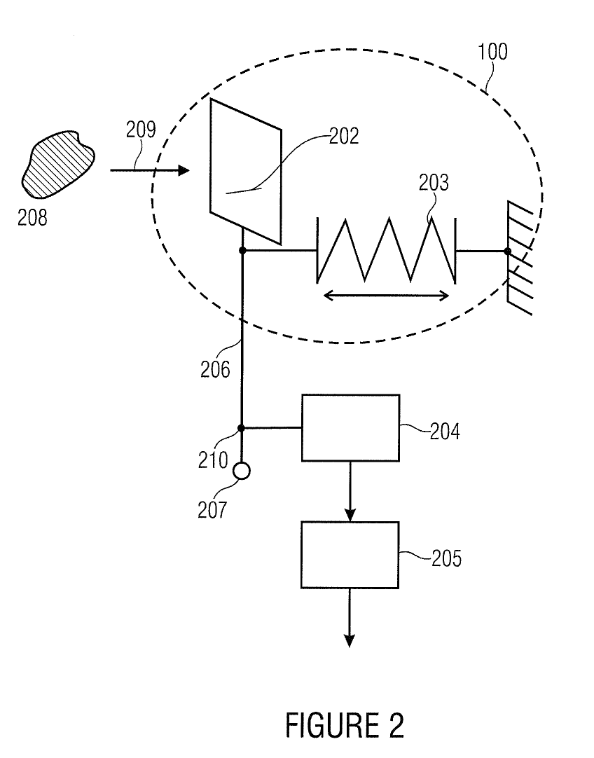

FIG. 2 shows a further embodiment of an inventive apparatus for classifying an object impinging along an object path.

FIG. 2 shows a target area 202, a spring 203, an acceleration sensor 204, and an evaluation unit 205. The target area 202 is connected, via a ridge 206, to a bearing 207 on which the ridge 206 is mounted so as to rotate in a unilateral manner. The spring 203 ensures that the ridge, when it is moved out of its resting position, will be restored by the spring force, so that after impingement of an object 208, the target area 202 will again be in the resting position.

The object 208 moves along an object path 209 and thus strikes the target area 202, which is deflected from its resting position so as to be restored to the resting position by the spring 203 for the next measurement. During the deflection, the acceleration sensor 204 continuously records the profile of the acceleration of the target area. This profile is evaluated by the evaluation unit 205 and used for classifying the impinging object. In the embodiment shown in FIG. 2, the spring 203 and the target area 202 thus form an impingement body 100 similar to the impingement body which is shown in FIG. 1.

In the description of the figures and in the further course of the application, the same functional components are given the same reference numerals, so that the descriptions thereof are mutually applicable within the descriptions of the figures of the individual embodiments.

The embodiment shown in FIG. 2 uses a construction which is particularly robust mechanically so as to realize the inventive apparatus for classifying an object impinging along an object path. A linking point 210, which establishes the frictional connection between the acceleration sensor 204 and the cantilever 206, may additionally be varied as desired in any problem-adapted manner so as to achieve the sensitivity of the acceleration sensor 204 which ideally fits the problem.

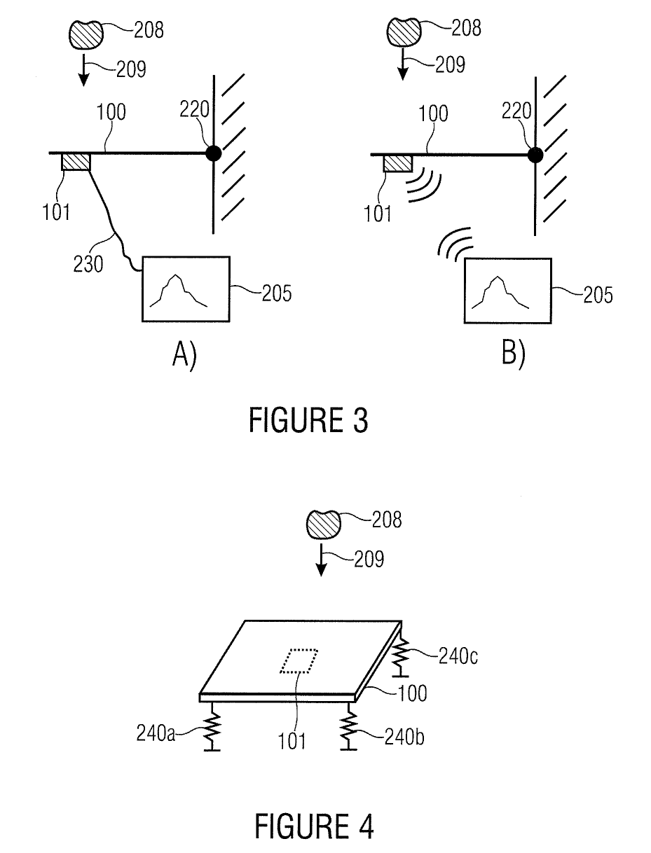

FIG. 3a shows a further embodiment of an inventive apparatus for classifying an object, the impingement body 100 being formed by a spring-steel lamella unilaterally fixed to a fixture 220, so that the spring-steel lamella is deflected from its resting position upon impingement of an object 208 which moves along an object path 209. The means for sensing a chronological acceleration profile 101 senses the acceleration of the spring-steel lamella 100 at the location of the sensing means 101 and transmits same to a classification means 205. Due to the characteristic acceleration profile, the classification means may classify the object 208 impinging on the spring-steel lamella 100 so as to distinguish a stone from pulp, for example.

Since, as has already been mentioned several times, it is solely due to the time-resolved acceleration measurement that it becomes possible to reliably distinguish stones from pulp, or hard objects from resilient ones, special care may be taken, in accordance with the invention, to ensure that the measurement is not distorted by external force influences.

Therefore, FIG. 3b shows a further embodiment of the apparatus for classifying an impinging object, wherein the means for sensing a chronological acceleration profile 101 is connected to the classification means 205 by means of a wireless interface in order to prevent any additional force influence due to a wired interface 230 as is shown in FIG. 3a. Such a wireless interface may be a Bluetooth, WLAN, infrared or laser interface, for example, or any other possibility of wireless communication. RFID techniques may also be utilized in a particularly useful manner in this context, wherein the means for sensing the chronological acceleration profile 101 may dispense with an energy source of its own but is supplied from the field of the RFID connection, so that the weight of the means for sensing a chronological acceleration profile 101 is not unnecessarily increased by potential accumulators or other energy carriers.

FIG. 4 shows a further embodiment of the present invention, wherein the impingement body 100 is held in its resting position by at least three springs 240a-240c arranged at the corners of the impingement body 100. In this context, the means for sensing the chronological acceleration profile 101 is advantageously arranged on the underside of the impingement body 100 so as to avoid any mechanical damage to or soiling of same. In a variation of the embodiment depicted in FIG. 4, the spring characteristic of the springs 240a-240c is progressive, i.e. the restoring force is smaller at the beginning of the deflection than toward the end of the maximum deflection, the latter being limited by the length of the spring. Since the restoring force of the spring impedes a measurement of the acceleration which is free from any constraining force, such an implementation of the springs is favorable so as to cause as little distortion of the measuring result as possible. The classification means is not depicted in FIG. 4; for the implementation thereof, or the connection thereof to the means for sensing the chronological acceleration profile 101, reference shall be made at this point to the explanations given with regard to the other figures, in particular FIGS. 3a and 3b.

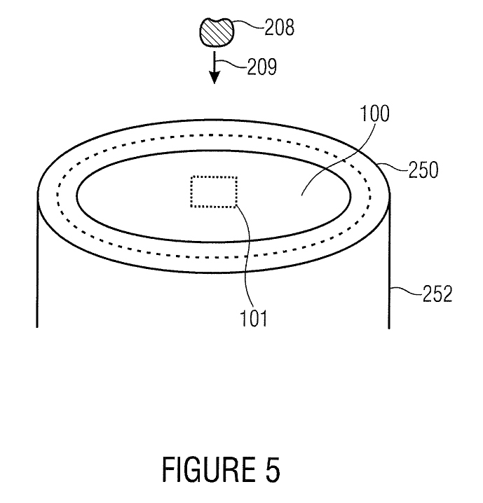

FIG. 5 shows a further embodiment of an inventive apparatus for classifying an object 208 impinging along an object path 209, the means for sensing a chronological acceleration profile 101 in this context being arranged on the underside of a membrane serving as the impingement body 100, which membrane is concentrically mounted on a rigid carrier 252 by means of a bead 250, as is common with loudspeakers, for example. For simplicity's sake, the classification means is not shown here either; for the embodiments of same, please also refer to the explanations given with regard to the remaining figures.

As has already been mentioned, stoning of stone fruit is to be understood only by way of example in this context, in order to illustrate the inventive concept. In accordance with the invention, it is also possible to determine the properties of any other bodies. For example, it may be checked whether a football is pumped up hard or whether it comprises such little internal pressure that it will significantly deform upon impinging on the impingement body.

In the scenario which is shown by way of the example of FIG. 1 for verifying successful stoning of stone fruit, the stone is removed from the fruit by means of a ram. However, the present invention is not limited to the way of removing a stone. The only thing that needs to be ensured is that the object to be classified impinges on the impingement body.

Also, the present invention is not limited to checking cherry stones, as is shown in FIG. 1. Rather, in addition to any objects desired, in particular stones of plums, peaches or apricots may be distinguished from the pulp of said fruits so as to verify the success of a stoning process.

The manner in which the acceleration of the impingement body is determined is not specified in any way. In a simple embodiment, use may be made of an acceleration sensor acting in a unidimensional manner which determines an acceleration only in one direction, which is advantageously parallel to the direction of impingement of the object. Alternatively, use may also be made of an acceleration sensor measuring in a three-dimensional manner so as to obtain additional information on the direction of impingement of the object to be classified. As has already been described, this may be useful when verifying the stoning of stone fruit so as to draw conclusions therefrom as to whether the stone has been fully or possibly only partly removed from the fruit. For simple differentiation whether particularly hard or particularly soft objects have hit the impingement body, in a simple embodiment of the present invention it is sufficient to determine the maximally occurring acceleration. This has the advantage that only little computing capacity may be used, and that the result is available immediately after impingement of the object. In an extended embodiment, the entire acceleration profile characteristic is used for achieving classification. In this context, conclusions may be drawn as to the hardness or viscosity of the object, in particular from the type of the increase in the acceleration, since a rapid increase indicates a hard object.

In a further embodiment one may determine, for example, the period of time within which the maximum acceleration is achieved, so as to be able to make safe and reliable statements about the hardness of the object more or less independently of the mass of the impinging object.

Depending on the circumstances, the inventive method for verifying the success of a stoning process performed with pieces of stone fruit may be implemented in hardware or in software. The implementation may be performed on a digital storage medium, in particular a disc or CD comprising electronically readable control signals which may cooperate with a programmable computer system such that the inventive method for verifying the success of a stoning process is performed. Generally, the invention thus also consists in a computer program product having a program code, stored on a machine-readable carrier, for performing the inventive method, when the computer program product runs on a computer. In other words, the invention may thus be realized as a computer program comprising a program code for performing the method, when the computer program runs on a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for classifying an object impinging along an object path, the apparatus comprising:
an impingement body arranged within the object path,
an acceleration sensor for sensing a chronological acceleration profile of the impingement body upon impingement of an object; and
a classifier for classifying the object on the basis of the chronological acceleration profile.

2. The apparatus as claimed in claim 1, wherein the acceleration sensor is implemented to three-dimensionally sense the acceleration profile manner.

3. The apparatus as claimed in claim 2, wherein the acceleration sensor is implemented to unidimensionally sense an acceleration in a direction which is essentially parallel to the object path.

4. The apparatus as claimed in claim 1, wherein the impingement body is partly deflected from a resting position upon impingement of the object.

5. The apparatus as claimed in claim 5, further comprising a restorer so as to return the impingement body to the resting position after it has been deflected.

6. The apparatus as claimed in claim 4, wherein the restorer is implemented to exert a restoring force, which acts progressively, on the impingement body.

7. The apparatus as claimed in claim 1, wherein the impingement body is a spring-steel lamella fixed on one side.

8. The apparatus as claimed in claim 1, wherein the impingement body comprises an impingement area which is spring-mounted at least three points, so that the impingement body may also be tilted if the object impinges in a non-central manner.

9. The apparatus as claimed in claim 1, wherein the impingement body comprises an impingement area which is held in a resting position by a spring.

10. The apparatus as claimed in claim 1, wherein the classifier is implemented to perform a classification on the basis of an observed overshoot of a predetermined acceleration threshold.

11. The apparatus as claimed in claim 1, wherein the classifier is implemented to perform a classification of the object on the basis of a chronological acceleration profile with a time resolution of less than ten milliseconds.

12. The apparatus as claimed in claim 1, wherein the classifier is implemented to perform the classification of the object on the basis of the maximally occurring acceleration of the chronological acceleration profile or of a period of time within which the maximally occurring acceleration is achieved.

13. The apparatus as claimed in claim 1, wherein the object is a tissue removed from a piece of stone fruit, and wherein the classifier is implemented to classify the object in terms of whether a stone is entirely comprised within the tissue.

13. The apparatus as claimed in claim 1, wherein the acceleration sensor for sensing a chronological acceleration profile is implemented to transmit a sensed acceleration profile via an RFID connection to the classifier, and to be supplied from the field of the RFID connection, so that the acceleration sensor may dispense with an energy source of its own.

14. The apparatus as claimed in claim 1, wherein the sensor for sensing a chronological acceleration profile is implemented such that the acceleration profile is represented in an analog signal.

15. The apparatus as claimed in claim 14, wherein the sensor for sensing a chronological acceleration profile is further implemented to digitize the analog signal.

16. The apparatus as claimed in claim 1, wherein the acceleration sensor is implemented as a chip which may communicate the acceleration profile sensed in a wireless manner.

17. The apparatus as claimed in claim 1, wherein the acceleration sensor is implemented as a discrete component so as to sense the acceleration profile without any mechanical reference.

18. The apparatus as claimed in claim 1, wherein the acceleration sensor is arranged on an underside of the impingement body which faces away from the object path.

19. A method of classifying an object impinging along an object path, the method comprising:
sensing, by means of an acceleration sensor, a chronological acceleration profile of an impingement body, which is arranged within the object path, during deflection of the impingement body from a resting position upon impingement of the object; and
classifying the object on the basis of the chronological acceleration profile.

20. A stoning apparatus for stone fruit, comprising:
a stoner for removing tissue along an object path from the stone fruit;
an impingement body arranged within the object path;
an acceleration sensor for sensing a chronological acceleration profile of the impingement body upon impingement of the tissue; and
a classifier for recognizing a stone within the tissue on the basis of the chronological acceleration profile.
